(19) United States
(12) Patent Application Publication
(10) Pub. No.: US 2006/0103517 A1
(43) Pub. Date: May 18, 2006

(54) Apparatus for indicating variations in the motion of transportation vehicles

(76) Inventor: Antimo Martin, Homestead, FL (US)

Correspondence Address: Antimo Martin, 13467 SW 278 Terrace, Homestead, FL, 33032, US

(21) Appl. No.: 10/970,633

(22) Filed: Oct. 21, 2004

(51) Int. Cl. B60Q 1/22; G01P 15/00; B60Q 1/50; B60Q 1/54; G09F 9/33

(52) U.S. Cl. 340/463; 73/488; 340/464; 340/466; 340/467; 340/815.45

(57) ABSTRACT

An apparatus for indicating variations in the motion of transportation vehicles that includes a luminous display in the rear part of the leading vehicle indicating changes in the motion of said vehicle. The apparatus also includes a sensor for detecting changes in motion connected to an electronic circuit that interprets said changes and produces the corresponding signal showed in the luminous display.

### FIELD OF THE INVENTION

An apparatus with a luminous display that indicates variations in the motion of transportation vehicles.

### BACKGROUND OF THE INVENTION

Many devices and methods have been described in the art to improve driver safety. Most of these inventions are directed to provide an early warning to the driver of the following vehicle of a potentially dangerous situation. See U.S. Pat. No. 6,604,592 (Pietsch, et al.); U.S. Pat. No. 6,674,261 (Takahashi, et al.); U.S. Pat. No. 6,684,149 (Nakamura, et al.); U.S. Pat. No. 6,738,088 (Uskolovsky, et al.) An example of this type of device is the rear red stoplight and its related modifications. See U.S. Pat. No. 3,949,361 (Replogle). However, there is still a need in the art for signaling devices that provide more relevant and complete information to the driver of the following vehicle.

### BRIEF DESCRIPTION OF THE FIGURES

FIG. 1 illustrates a perspective view of the present invention.

FIG. 2 illustrates a cut view of the present invention.

FIG. 3 illustrates a schematic diagram of the acceleration measuring circuit and power supply.

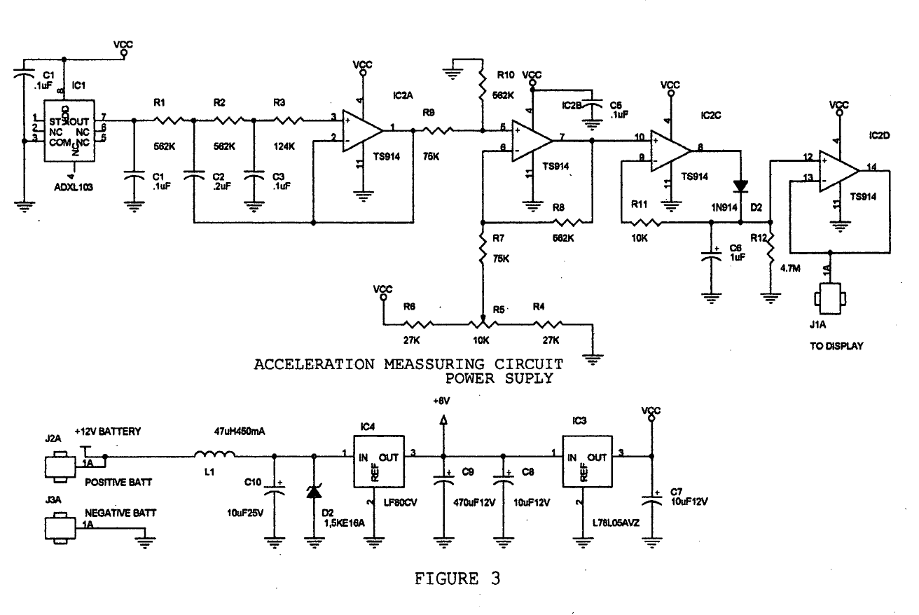

FIG. 4 illustrate a schematic diagram of the display circuit.

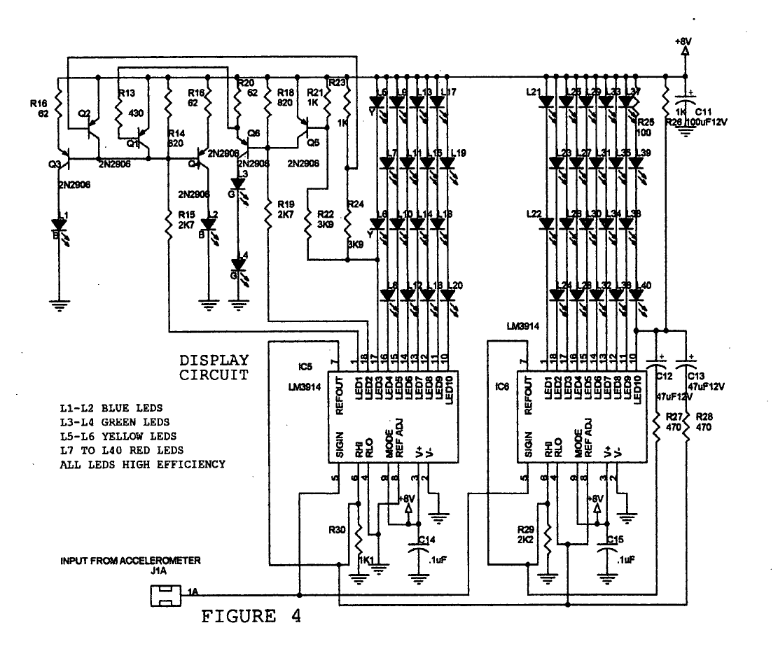

### SUMMARY OF THE INVENTION

None of the devices known in the art provides the driver of the following vehicle with information about the type and intensity of the change in motion of the leading vehicle. The present invention describes an apparatus for achieving this objective that is effective and economical to build and to implement.

The present invention refers to an apparatus that incorporates a sensing mean connected to an electronic circuit. The circuit is in turn connected to a signaling mean that displays a signal according to the change in the motion of a vehicle. The display of the signal is also proportional to the intensity of the change in motion.

In an embodiment of the present invention, the sensing mean is a speedometer. In one version of this component, the speedometer obtains the derivative of the speed by means of a capacitor. In another version of this component, the speedometer obtains the digital equivalent of the acceleration by means of software, if the speedometer is digital or microprocessor based, or by an ABS system when the speed is obtained from the rotation of the wheel or wheels and the acceleration is obtained by producing the derivative of the speed or by an accelerometer. Preferably, the sensing mean is an accelerometer, for redundancy purposes. More preferably, the accelerometer is of the IC type (ADXL103). Examples of the electronic circuit that could be used according to the present invention include, but are not limited to, suitable analog or digital circuits. Preferably, the electronic circuit utilized is an analog integrated circuit. More preferably, the analog integrated circuit is an opAmp quadruple type (TS914) circuit.

In an embodiment of the present invention, the signaling mean is an attention capturing system producing sound or light or any combination thereof. When a light display is utilized, it may be a liquid crystal display, a multiple lamps rack, a light emitting diodes (LED's) display or any combination thereof.

In an embodiment of the present invention the maximum deceleration is stored for a certain period of time in order to indicate to the following driver that a change in motion has taken place.

In an embodiment of the present invention the signaling mean is attached to the rear of the leading vehicle. In this case the signaling mean may be located inside or outside the leading vehicle. The signaling mean may be placed vertically or horizontally. Preferably, the signaling mean is placed vertically.

### DESCRIPTION OF THE INVENTION

One general scheme of making the present invention incorporates a signal display placed vertically or horizontally in the rear of the vehicle containing several LEDs or lamps. The lights could be of the same color or a combination of different colors. The signal display is connected to the electronic circuit and an accelerometer.

An example of the aforementioned scheme includes a row of twenty pairs of LEDs arranged vertically. In this case, the bottom pair of lights is blue, the next following pair is green, the next pair is yellow, and the next seventeen pairs are red. As the vehicle accelerates the yellow lights goes to green, and if the acceleration keeps increasing the light goes to blue. If the acceleration increases further the entire display goes off. As the vehicle decreases acceleration and starts cruising, the lights turn in the reverse order. This phenomenon indicates the following driver that the leading vehicle is cruising. If the leading vehicle starts slowing down or breaking, the red lights also turn on according to the deceleration. The faster the vehicle decelerates the more LEDs turn on indicating the following driver how fast the leading vehicle is decelerating or breaking. If the deceleration reaches or exceeds a pre-determined maximum value all the lights start flashing indicating danger to the following driver.

Further objects of the invention will be brought out in the following part of the specification, wherein detailed description is for the purpose of fully disclosing the invention without placing limitations thereon.

### EXAMPLE 1

### Accelerometer Coupled to Circuit and Signal Display

A prototype of the instant invention device was built according to the following protocol:

1. Accelerometer

The device incorporates an IC1 accelerometer (ADXL103). This IC produces an analog output voltage proportional to acceleration. If it is fed with a 5 volt power supply, its output is ratio metric.

R1, R2, R3, C2, C3, IC2A compose a low pass filter. This eliminates high frequency components that would produce fast moving and erratic signals from the voltage signal coming out of the accelerometer.

R9, R7, R8, R10, IC2B compose a differential amplifier that compares the output of the filter to a fixed voltage obtained from the voltage divider R4, R5, R6. This divider allows the adjustment of the signal lights in the display that are turned on when the vehicle is cruising. The change in the ratio of R9, R7 (R8, R10) allows to make the device more or less sensitive to changes in acceleration.

C6, R12, IC2C, D2 compose a peak detector. This circuit stores the last peak value of the deceleration allowing the driver of the following vehicle to see the signal for a longer period of time. A modification of the value of C6 allows for changes in this time.

IC3, IC4 compose the power supply of the system, which has been designed to operate from 12 Volt batteries. D2 protects the entire system against transient voltages.

2. System

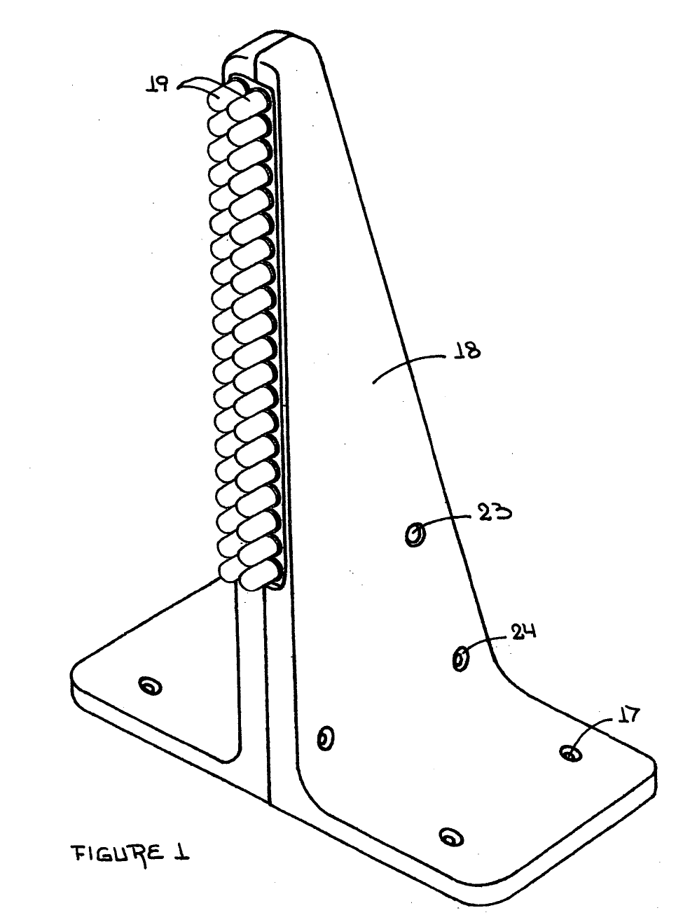

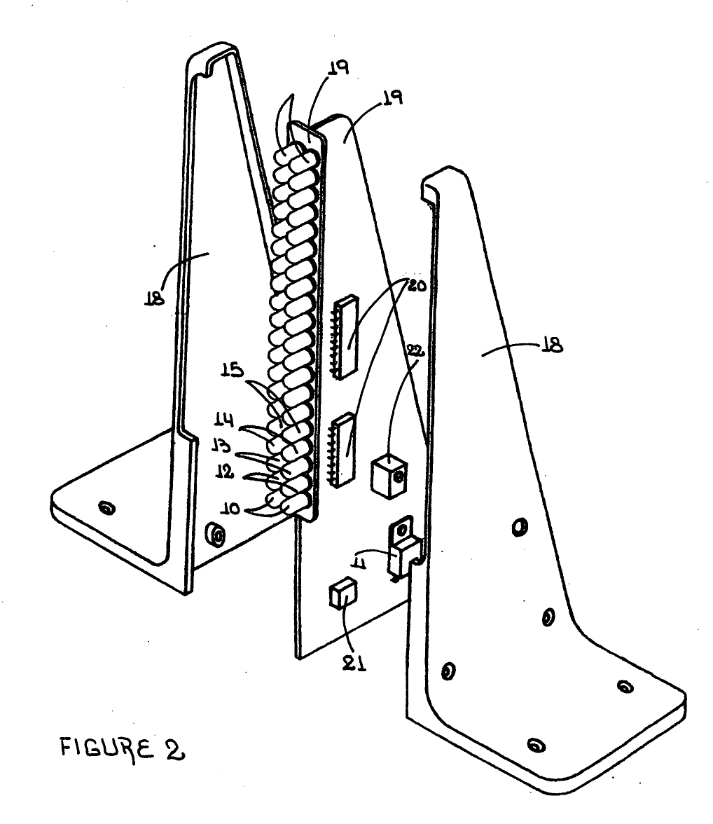

A housing includes a wall, a mounting system 17, a printed circuit board 19 and signal lights 10, 12, 13, 14 and 15 (LEDs) was built. See FIGS. 1 and 2.

The electronic components 20 are soldered in printed circuit board 19. In particular, accelerometer 21 is mounted with the proper mechanical orientation to the direction of travel of the vehicle.

Signal lights 10 are blue or other suitable color.

Signal lights 12 are green or other suitable color.

Signal lights 13 are yellow or other suitable color.

Signal lights 14 to 15 are all red or other suitable color.

In operation and when the vehicle is cruising (moving at constant speed) signal lights 13 are on.

If the vehicle accelerates, signal lights 12 (green) turn on, and signal lights 13 (yellow) turn off indicating to the following vehicle the leading vehicle is accelerating.

If the vehicle accelerates further additional signal lights 12 (green) turn off and signal lights 10 (blue) turn on. If the vehicle continues to accelerate the entire display lights turn off. If the vehicle stops accelerating, the reverse occurs, going back to lights 13 (yellow). If the vehicle starts slowing down or breaking, signal lights 14 (red) turn on in a manner proportional to the degree and intensity of the deceleration. If signal lights 19 turn on because of the intensity of the deceleration, the entire red display flashes 4 times a second until the deceleration decreases. This limit value can be internally adjusted.

Incandescent color lights could be used in place of LEDs substantially rendering the same effect.

The present invention has been described in some detail and exemplified to facilitate its understanding and reproducibility. Certain changes in the form and detail can be made by anyone skilled in the art without departing from the true object and scope of the claims of the present invention. All the publications quoted herein are incorporated in their totality as references to the description of the invention.

What is claimed is:

1. An apparatus for indicating variations in the motion of transportation vehicles comprising: (i) a sensing mean connected to an electronic circuit and (ii) a signaling mean circuit connected to the electronic circuit.

2. An apparatus, according to claim 1, wherein the sensing mean comprises a speedometer.

3. An apparatus, according to claim 1, wherein the sensing mean comprises an accelerometer.

4. An apparatus, according to claim 3, wherein the accelerometer is an IC type accelerometer.

5. An apparatus, according to claim 1, wherein the electronic circuit comprises an analog or digital circuit.

6. An apparatus, according to claim 5, wherein the electronic circuit is analog.

7. An apparatus, according to claim 6, wherein the analog circuit is an opAmp quadruple type circuit.

8. An apparatus, according to claim 1, wherein the signaling mean comprises a sound emitter or light display.

9. An apparatus, according to claim 8, wherein the light display comprises a liquid crystal display, a multiple lamps rack or a light emitting diodes display.

10. An apparatus, according to claim 1, wherein the signaling mean is located in the rear part of the leading car.

11. An apparatus, according to claim 1, wherein the signaling mean is located vertically.

12. An apparatus, according to claim 1, wherein the signaling mean is located horizontally.
